(19) United States
(12) Patent Application Publication
(10) Pub. No.: US 2011/0064472 A1
(43) Pub. Date: Mar. 17, 2011

(54) DEVELOPING DEVICE AND IMAGE FORMING APPARATUS

(75) Inventor: Hideto SAKURAI, Toyokawa-shi (JP)

(73) Assignee: Konica Minolta Business Technologies, Inc., Chiyoda-ku (JP)

(21) Appl. No.: 12/879,135

(22) Filed: Sep. 10, 2010

(30) Foreign Application Priority Data
Sep. 16, 2009 (JP) 2009-214194

(51) Int. Cl. G03G 15/08

(52) U.S. Cl. 399/254

(57) ABSTRACT

There is provided a developing device capable of preventing a carrier from abrading a shaft section of an agitating conveyance member facing a sealing member and preventing toner leakage resulting from the abrasion. A sealing member 21 is for sealing a clearance between a housing 13 and a shaft section 141 of an agitating conveyance member 14. A magnet 22 forms a magnetic shield in a radial direction orthogonal to the shaft section 141 of the agitating conveyance member 14. The magnet 22 is placed on the inner side of the sealing member 21 inside the housing 13.

This application is based on application No. 2009-214194 filed in Japan on Sep. 16, 2009, the entire content of which is hereby incorporated by reference.

### BACKGROUND OF THE INVENTION

1. Field of the Invention

The present invention relates to a developing device for use in an electrophotographic image forming apparatus, and an image forming apparatus with use of the developing device.

2. Description of the Related Art

Electrophotographic image forming apparatuses generally include an image carrier, a charging device for uniformly charging the surface of the image carrier, an exposure device for forming an electrostatic latent image from electric charge on the image carrier, a developing device for forming a visible image from the electrostatic latent image on the image carrier with use of a developer, a transfer device for electrically and mechanically transferring the visible image on the image carrier onto a recording medium, a cleaning device for removing the developer remained on the image carrier in the transfer operation with the transfer device, and a fixing device for permanently fixing the visualized developer on the recording medium with heat and pressure.

The developing device includes a housing for storing a two-ingredient developer containing a toner and a carrier, a screw member for conveying, while agitating, the developer in the housing, a developing roller for carrying the developer conveyed by the screw member and transferring the carried developer onto the image carrier, and a sealing member for sealing a clearance between the housing and a shaft section of the screw member.

There is a problem that the surface of the shaft section is abraded by the carrier invading in between the sealing member and the shaft section of the screw member, and this abrasion may deteriorate a sealing property, resulting in leakage of the developer.

To solve the problem, various proposals have conventionally been made as described below.

In JP H5-134540 A (Patent Literature 1), a carrier seal is formed with use of a magnet and a magnetic plate to suppress invasion of toner into a bearing.

However, in this configuration, a carrier seal cannot always be formed due to backlash of the shaft section of a screw member in an axial thrust direction, which causes a toner leakage problem. Moreover, since no sealing member is provided therein, it is impossible to prevent toner leakage.

In JP 2002-357217 A (Patent Literature 2), a configuration has been proposed in which magnets are placed on an end portion of a screw member and the entire surface of a housing which faces the end portion.

However in this configuration, a carrier seal cannot always be formed due to backlash of a shaft section of the screw member in an axial thrust direction, which causes a toner leakage problem. Moreover, since no sealing member is provided therein, it is impossible to prevent toner leakage.

In JP 2003-91157 A (Patent Literature 3), a configuration has been proposed in which both a magnet and a sealing member are used to prevent invasion of a developer to a bearing and in which a buffer board is used to temporarily receive the developer conveyed by a screw member to reduce pressure of the developer.

However in this configuration, since the sealing member is on the inner side of the magnet, a carrier invades in between the sealing member and a shaft section of the screw member, which makes it impossible to prevent the carrier from abrading the shaft section of the screw member, and the space for the buffer board goes to waste.

### SUMMARY OF INVENTION

It is an object of the invention to prevent carrier from abrading a shaft section of an agitating conveyance member which faces a sealing member and to prevent toner leakage resulting from the abrasion.

In order to achieve the above object, there is provided a developing device comprising:

a housing for storing a developer including a toner and a carrier;

an agitating conveyance member having a shaft section rotatably attached to the housing for conveying, while agitating, the developer in the housing;

a developing roller attached to the housing for carrying the developer conveyed by the agitating conveyance member to feed the carried developer to the image carrier;

a sealing member mounted on the housing for sealing a clearance between the housing and the shaft section of the agitating conveyance member; and

a magnet for providing a magnetic shield in a radial direction orthogonal to the shaft section of the agitating conveyance member, the magnetic shield being positioned at an axial end of the agitating conveyance member and placed on an inner side of the sealing member in the housing.

The developing device of the invention includes a sealing member for sealing a clearance between the housing and the shaft section of the agitating conveyance member and a magnet forming a magnetic shield in a radial direction orthogonal to the shaft section of the agitating conveyance member, so that leakage of the toner within the housing to the outside of the housing is suppressed by the sealing member, and leakage of the carrier within the housing to the outside of the housing is suppressed by the magnet.

Since the magnet is placed on the inner side of the sealing member in the housing, invasion of the carrier within the housing to the sealing member side is prevented by the magnet. Accordingly, it becomes possible to prevent the carrier from entering to between the sealing member and the shaft section and abrading the surface of the shaft section, resulting in prevention of toner leakage caused by the abrasion.

A magnet forms a magnetic shield in a radial direction, so that the magnetic shield can be maintained even with backlash of the shaft section in a thrust direction along the shaft section, which makes it possible to prevent carrier leakage to the sealing member side and to prevent toner leakage caused by abrasion of the shaft section by the carrier.

Therefore, it becomes possible to prevent the carrier from abrading the shaft section of the agitating conveyance member facing the sealing member and to prevent toner leakage resulting from the abrasion.

Also, there is provided an image forming apparatus, comprising:

an image carrier capable of carrying an electrostatic latent image based on image data on a surface thereof;

a developing device for feeding a toner to the surface of the image carrier;

a transfer device for transferring the toner image on the image carrier onto a paper sheet; wherein

the developing device comprises:

a housing for storing a developer including the toner and a carrier;

an agitating conveyance member having a shaft section rotatably attached to the housing for conveying, while agitating, the developer in the housing;

a developing roller attached to the housing for carrying the developer conveyed by the agitating conveyance member to feed the carried toner to the image carrier;

a sealing member mounted on the housing for sealing a clearance between the housing and the shaft section of the agitating conveyance member; and

a magnet for providing a magnetic shield in a radial direction orthogonal to the shaft section of the agitating conveyance member, the magnetic shield being positioned at an axial end of the agitating conveyance member and placed on an inner side of the sealing member in the housing.

Since the image forming apparatus of the invention includes the developing device, contamination of the inside of the apparatus by the toner can be prevented.

### BRIEF DESCRIPTION OF DRAWINGS

The present invention will become more fully understood from the detailed description given hereinbelow and the accompanying drawings which are given by way of illustration only, and thus are not intended to limit the present invention, and wherein:

FIG. 1 is a simplified structure view showing an image forming apparatus in one embodiment of the invention;

FIG. 2 is a cross sectional view showing a developing device in a first embodiment of the invention;

FIG. 3 is a cross sectional view of FIG. 2 taken along an A-A line;

FIG. 4 is a simplified structure view showing principal parts of the developing device;

FIG. 5 is a simplified structure view showing principal parts of the developing device in a second embodiment of the invention;

FIG. 6 is a simplified structure view showing principal parts of the developing device in a third embodiment of the invention;

FIG. 7 is a simplified structure view showing principal parts of the developing device in a fourth embodiment of the invention;

FIG. 8 is a simplified structure view showing principal parts of the developing device in a fifth embodiment of the invention; and

FIG. 9 is a simplified structure view showing principal parts of the developing device in a sixth embodiment of the invention.

### DESCRIPTION OF THE PREFERRED EMBODIMENTS

Hereinbelow, the invention will be described in detail in conjunction with the embodiments with reference to the drawings.

### First Embodiment

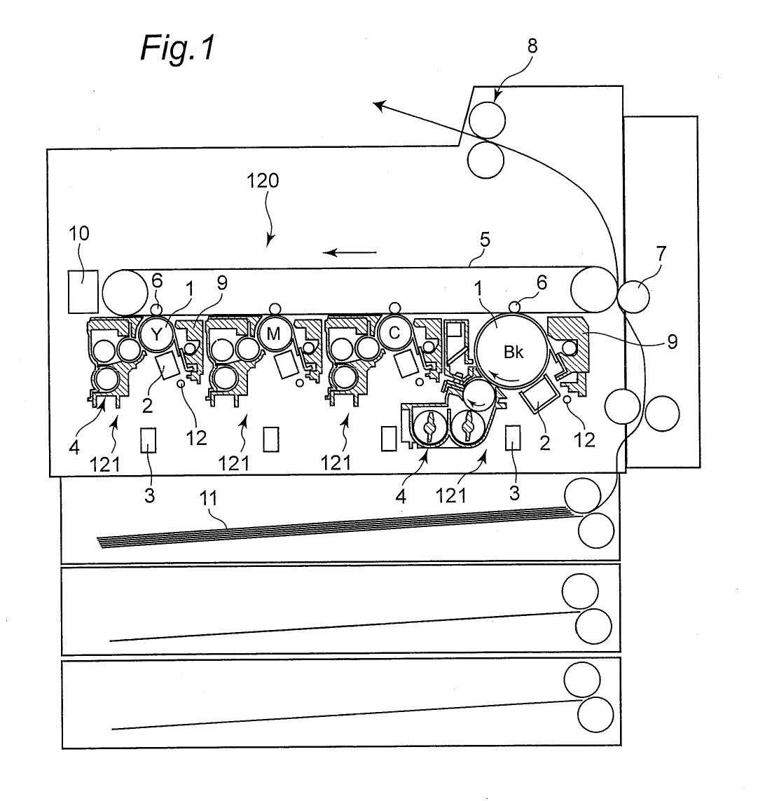

FIG. 1 is a simplified structure view of an image forming apparatus in one embodiment of the invention. This image forming apparatus is a full color electrophotographic apparatus having an imaging device 120 and a fixing device 8.

The imaging device 120 attaches an unfixed toner onto a recording medium 11 (e.g., paper) to form an image. The fixing device 8 melts the toner and fixes it to the recording medium 11.

The imaging device 120 is composed of a transfer belt 5, four image forming units 121 placed along the transfer belt 5, and a secondary transfer device 7 placed facing the transfer belt 5.

The image forming unit 121 forms a toner image, and transfers the toner image onto the transfer belt 5. The secondary transfer device 7 transfers the toner image, which was transferred onto the transfer belt 5, onto a recording medium 11.

An image forming unit 121 for forming toner images in black (Bk), an image forming unit 121 for forming toner images in yellow (Y), an image forming unit 121 for forming toner images in magenta (M), and an image forming unit 121 for forming toner images in cyan (C) are placed in the vicinity of the transfer belt 5.

Each of the image forming units 121 has an image carrier 1, a charging device 2, an image exposure device 3, a developing device 4, a transfer belt 5, and a primary transfer device 6.

The image carrier 1 is a so-called photoconductor. The charging device 2 uniformly charges the surface of the image carrier 1 to form a potential. The image exposure device 3 applies light to form a predetermined electrostatic latent image on the image carrier 1 which was charged to a desired potential by the charging device 2. The developing device 4 attaches a toner onto the region where the electrostatic latent image was formed by means of electric fields and the like for development of the toner. The primary transfer device 6 moves the developed toner on the image carrier 1 onto the transfer belt 5.

Description is now given of the function of the image forming apparatus.

The toner image developed on the image carrier 1 of the image forming unit 121 is primarily transferred onto the transfer belt 5 at a contact position with the transfer belt 5.

Whenever a toner image transferred onto the intermediate transfer belt 5 passes each of the image forming units 121, respective colors are laid on top of each other, resulting in formation of a full color toner image formed on the transfer belt 5.

Then, the full color toner image on the transfer belt 5 is secondarily transferred onto the recording medium 11 as a group by the secondary transfer device 7.

As the recording medium 11 passes the fixing device 8 positioned downstream from a transfer position on a conveying path of the recording medium 11, the toner image is fixed. The recording medium 11 with the toner image fixed thereon is then delivered to the outside of the apparatus.

Meanwhile, some of the toner may not be moved onto the transfer belt 5 in the primary transfer device 6, as a result of which a small amount of toner may remain on the image carrier 1. In this case, the toner remaining on the image carrier 1 is mechanically removed from the surface of the image carrier 1 by a cleaning device 9. The image carrier 1 is then discharged by an electric discharger 12.

As for the developed image formed on the transfer belt 5, some of the toner may not be moved onto the recording medium 11 in the secondary transfer, as a result of which a small amount of toner may remain on the transfer belt 5 as residual toner. The residual toner on the transfer belt 5 is removed electrically and mechanically by a transfer belt cleaning device 10.

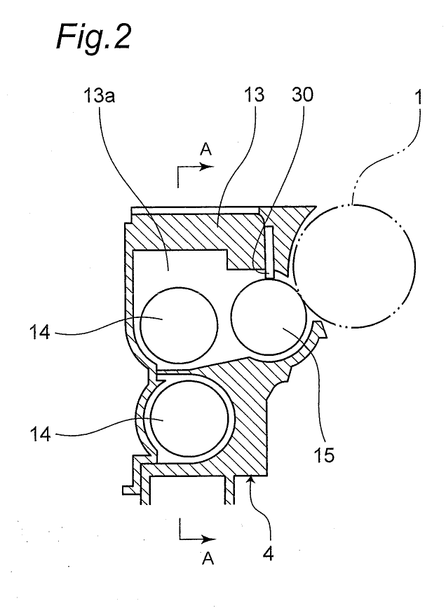

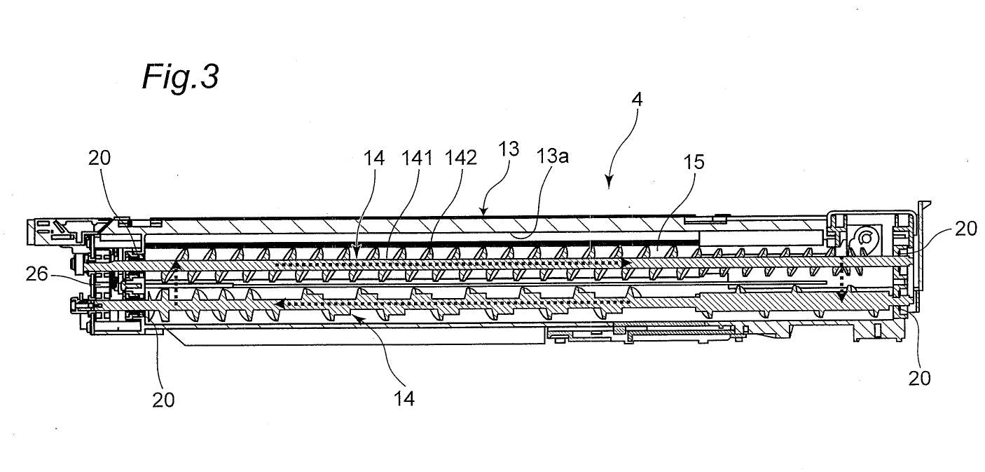

As shown in FIG. 2 and FIG. 3, the developing device 4 has a housing 13 for storing a developer including a toner and a carrier, and an agitating conveyance member 14, a developing roller 15, a regulating member 30 and a seal body 20 which are mounted on the housing 13. The housing 13 has a developer storing space 13a for storing the developer.

The agitating conveyance member 14 has a shaft section 141 and a screw section 142 attached to the shaft section 141. The shaft section 141 is rotatably attached to the housing 13. The screw section 142 is placed within the developer storing space 13a of the housing 13. The screw section 142 of the agitating conveyance member 14 conveys, while agitating, the developer inside the housing 13. In the present embodiment, there are two agitating conveyance members 14, which circulate the developer as shown with arrowed dotted lines in FIG. 3.

The developing roller 15 carries the developer conveyed by the agitating conveyance member 14 so that the carried developer is fed to the image carrier 1. The regulating member 30 regulates the quantity of the developer on the developing roller 15 to be constant.

An unshown developing gear is mounted on the developing roller 15, and a conveyance gear 26 is mounted on the shaft section 141 of the agitating conveyance member 14. The developing gear and the conveyance gear 26 are engaged via an unshown idler gear. The developing gear, the idler gear and the conveyance gear 26 are attached to the housing 13.

The seal body 20 is constituted so that the developer within the housing 13 does not leak from a clearance between the housing 13 and the shaft section 141 of the agitating conveyance member 14. The seal body 20 is provided in both the ends of the shaft section 141.

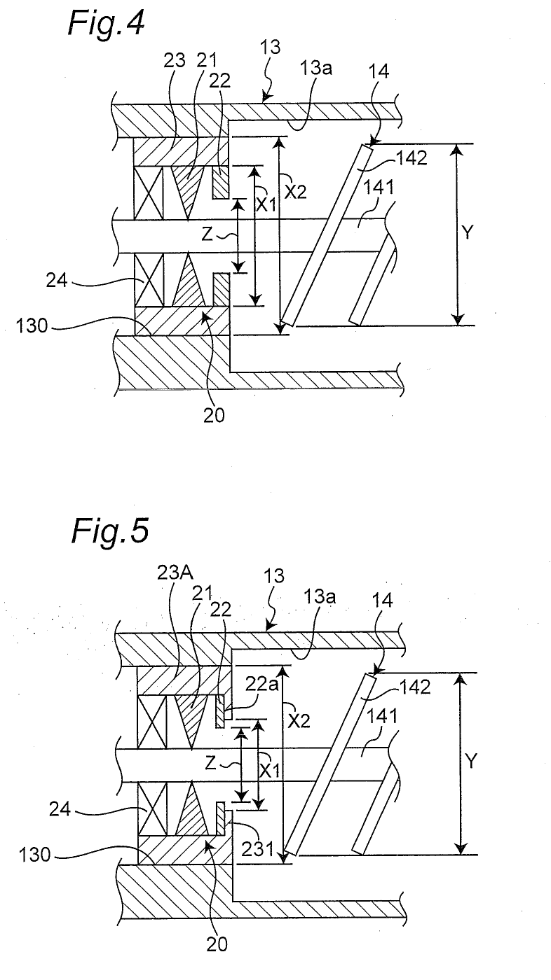

As shown in FIG. 4, the seal body 20 has a sealing member 21 and a magnet 22.

The sealing member 21 is mounted on the housing 13 side. The sealing member 21 is for sealing the clearance between the housing 13 and the shaft section 141 of the agitating conveyance member 14. The sealing member 21 is an annular member made of, for example, PTFEs.

The magnet 22 is mounted on the housing 13 side so as to have a distance to the shaft section 141 of the agitating conveyance member 14. The magnet 22 is placed on the inner side of the sealing member 21 in a longitudinal direction of the housing 13 (on the developer storing space 13a side). The longitudinal direction of the housing 13 is coincident with the shaft direction of the agitating conveyance member 14. The magnet 22 forms a magnetic shield in a radial direction orthogonal to the shaft section 141 of the agitating conveyance member 14. The magnet 22 is an annular member formed by, for example, alternately placing N pole and S pole in a circumferential direction.

When the developer is going to move to the axial outside of the agitating conveyance member 14, the carrier is attracted to the magnet 22 side. In this case, although the toner moves to the outer side of the magnet 22 in the shaft direction of the agitating conveyance member 14 as the toner is not attracted to the magnet 22, the sealing member 21 seals the housing so that the toner is prevented from leaking to the longitudinal outside of the housing 13. Since the toner is generally lower in hardness than carrier, it is less likely to abrade the shaft section 141 when it enters in between the sealing member 21 and the shaft section 141 of the agitating conveyance member 14. Accordingly, it is not a cause for concern even if the toner passes the magnet 22 and moves to the sealing member 20 side in the shaft direction.

The housing 13 has a hole section 130 for receiving the shaft section 141 of the agitating conveyance member 14. An annular retaining member 23 is mounted on the inner surface of the hole section 130. The sealing member 21 and the magnet 22 are mounted on the inner surface of the retaining member 23.

A bearing member 24 is mounted on the inner surface of the retaining member 23. The bearing member 24 holds the shaft section 141 of the agitating conveyance member 14. The bearing member 24 is separated from the sealing member 21 so as not to retain the sealing member 21. The bearing member 24 is placed on the outer side of the sealing member 21 in the longitudinal direction of the housing 13.

The sealing member 21, the magnet 22, and the bearing member 24 are integrally attached to the retaining member 23 to form a unit. This unit is mounted on the hole section 130 of the housing 13.

An inner diameter X1 of the retaining member 23 inward in the longitudinal direction of the housing 13 is smaller than an inner diameter X2 of the hole section 130 inward in the longitudinal direction of the housing 13.

The inner diameter X1 of the retaining member 23 inward in the longitudinal direction of the housing 13 is smaller than an external diameter Y of the screw section 142 of the agitating conveyance member 14 on the sealing member 21 side. An inner diameter Z of the magnet 22 is smaller than the outer diameter Y of the screw section 142 of the agitating conveyance member 14 on the sealing member 21 side.

The above-configured developing device includes a sealing member 21 for sealing a clearance between the housing 13 and the shaft section 141 of the agitating conveyance member 14, and a magnet 22 forming a magnetic shield in a radial direction orthogonal to the shaft section 141 of the agitating conveyance member 14, so that leakage of the toner within the housing 13 outward in the longitudinal direction of the housing 13 is suppressed by the sealing member 21, and carrier leakage within the housing 13 outward in the longitudinal direction of the housing 13 is suppressed by the magnet 22.

Since the magnet 22 is placed on the inner side of the sealing member 21 in the longitudinal direction of the housing 13, the carrier within the housing 13 is prevented from invading to the sealing member 21 side by the magnet 22. Accordingly, it becomes possible to prevent the carrier from entering to between the sealing member 21 and the shaft section 141 and abrading the surface of the shaft section 141, resulting in prevention of toner leakage caused by the abrasion.

Moreover, since the magnet 22 forms a magnetic shield in the radial direction, the magnetic shield can be maintained even with backlash of the shaft section 141 in the thrust direction along the shaft section 141. Accordingly, carrier leakage to the sealing member 21 side can be prevented, resulting in prevention of toner leakage caused by abrasion of the shaft section 141 by the carrier.

Therefore, it becomes possible to prevent the carrier from abrading the shaft section 141 of the agitating conveyance member 14 facing the sealing member 21 and to prevent toner leakage resulting from the abrasion.

The annular retaining member 23 is mounted on the inner surface of the hole section 130 of the housing 13, and a sealing member 21 is mounted on the inner surface of the retaining member 23, which allows easy mounting of the sealing member 21 together with the retaining member 23 on the hole section 130 of the housing 13.

Moreover, since the inner diameter X1 of the retaining member 23 inward in the longitudinal direction of the housing 13 is smaller than the outer diameter Y of the screw section 142 of the agitating conveyance member 14 on the sealing member 21 side, most part of the carrier flown to the magnet 22 side by the screw section 142 hits the housing 13 and the retaining member 23 without directly hitting the magnetic shield. This further ensures prevention of carrier leakage from the magnetic shield to the sealing member 21.

Moreover, the annular magnet 22 is mounted on the inner surface of the retaining member 23, which allows easy mounting of the magnet 22 together with the retaining member 23 on the hole section 130 of the housing 13.

Since the inner diameter Z of the magnet 22 is smaller than the outer diameter Y of the screw section 142 of the agitating conveyance member 14 on the sealing member 21 side, most part of the carrier flown to the magnet 22 side by the screw section 142 hits the housing 13 and the retaining member 23 without directly hitting the magnetic shield. This further ensures prevention of carrier leakage from the magnetic shield to the sealing member 21.

Since the bearing member 24 is placed away from the sealing member 21 so as not to retain the sealing member 21, the sealing member 21 does not directly receive vibration caused by sliding of the bearing member 24 and the shaft section 141, which helps to further secure the sealing property.

Since the above-configured image forming apparatus includes the above-configured developing device, contamination of the inside of the apparatus by the toner can be prevented.

### Second Embodiment

FIG. 5 shows a developing device in a second embodiment of the invention. The second embodiment is different from the first embodiment in the structure of the retaining section. It is to be noted that in the second embodiment, component members identical to those in the first embodiment are designated by identical reference numerals to omit detailed explanation.

As shown in FIG. 5, on the inner surface of the retaining member 23A, a flange 231 projecting radially inside is provided at a part inward in the longitudinal direction of the housing 13. The flange 231 covers a side surface 22a of the magnet 22 inward in the longitudinal direction of the housing 13.

An inner diameter X1 of the retaining member 23A inward in the longitudinal direction of the housing 13 is equivalent to an inner diameter of the flange 231, the inner diameter X1 being smaller than an inner diameter X2 of the hole section 130 of the housing 13 inward in the longitudinal direction of the housing 13.

An inner diameter Z of the magnet 22 is smaller than the inner diameter X1 of the retaining member 23A inward in the longitudinal direction of the housing 13.

The inner diameter X1 of the retaining member 23A inward in the longitudinal direction of the housing 13 is smaller than the outer diameter Y of the screw section 142 of the agitating conveyance member 14 on the sealing member 21 side.

In the above-configured developing device, the flange 231 of the retaining member 23A covers the side surface 22a of the magnet 22 inward in side the longitudinal direction of the housing 13, so that invasion of the developer to the magnet 22 and an influence of the magnetism by the magnet 22 upon the inside of the longitudinal direction of the housing 13 can be reduced by the flange 231.

### Third Embodiment

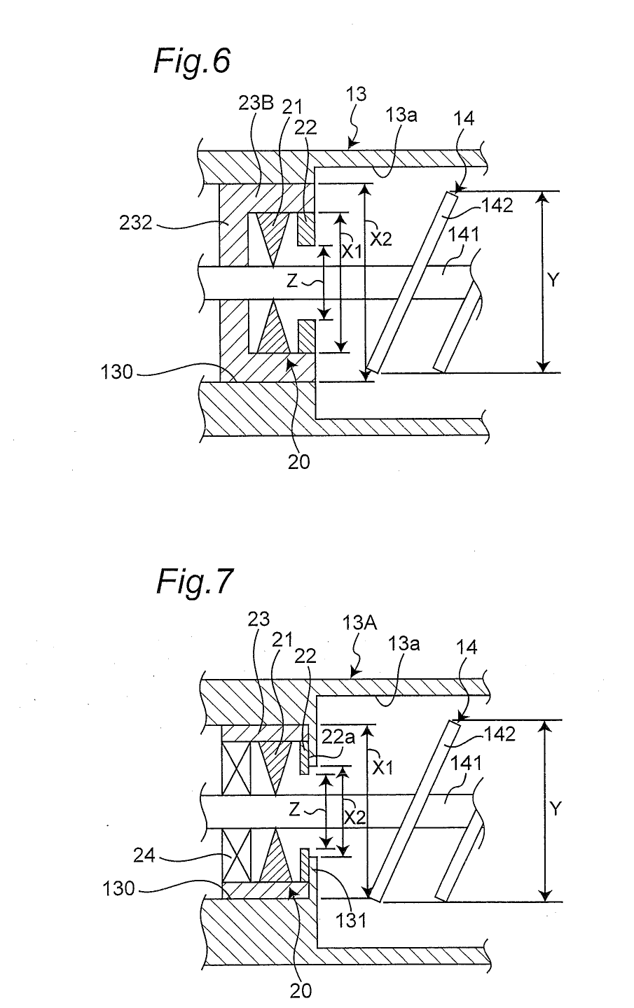

FIG. 6 shows a developing device in a third embodiment of the invention. The third embodiment is different from the first embodiment in the structure of the retaining section. It is to be noted that in the third embodiment, component members identical to those in the first embodiment are designated by identical reference numerals to omit detailed explanation.

As shown in FIG. 6, on the inner surface of a retaining member 23B, a bearing section 232 projecting radially inside is provided in a part inward in the longitudinal direction of the housing 13. The bearing section 232 holds the shaft section 141 of the agitating conveyance member 14 in place of the bearing member 24 of the first embodiment. The bearing section 232 is placed on the outer side of the sealing member 21 in the longitudinal direction of the housing 13.

In short, the retaining member 23B holds the sealing member 21 while holding the shaft section 141 of the agitating conveyance member 14.

In the above-configured developing device, the retaining member 23B serves also as a bearing, so that the number of components can be decreased.

### Fourth Embodiment

FIG. 7 shows a developing device in a fourth embodiment of the invention. The fourth embodiment is different from the first embodiment in the structure of the retaining section. It is to be noted that in the fourth embodiment, component members identical to those in the first embodiment are designated by identical reference numerals to omit detailed explanation.

As shown in FIG. 7, on the inner surface of the hole section 130 of a housing 13A, a flange 131 projecting radially inside is provided in a part inward in the longitudinal direction of the housing 13A. The flange 131 covers a side surface 22a of the magnet 22 inward in the longitudinal direction of the housing 13A.

An inner diameter X2 of the hole section 130 of the housing 13A inward in the longitudinal direction of the housing 13A is equivalent to an inside diameter of the flange 131, the inner diameter X2 being smaller than an inner diameter X1 of the retaining member 23 inward in the longitudinal direction of the housing 13A.

An inner diameter Z of the magnet 22 is smaller than the inner diameter X2 of the hole section 130 of the housing 13A inward in the longitudinal direction of the housing 13.

The inner diameter X2 of the hole section 130 of the housing 13A inward in the longitudinal direction of the housing 13A is smaller than the outer diameter Y of the screw section 142 of the agitating conveyance member 14 on the sealing member 21 side.

In the above-configured developing device, the flange 131 of the housing 13A covers the side surface 22a of the magnet 22 inward in the longitudinal direction of the housing 13A, so that invasion of the developer to the magnet 22 and an influence of the magnetism by the magnet 22 inward in the longitudinal direction of the housing 13A can be reduced by the flange 131.

Moreover, since the inner diameter X2 of the hole section 130 of the housing 13A inward in the longitudinal direction of the housing 13A is smaller than the outer diameter Y of the screw section 142 of the agitating conveyance member 14 on the sealing member 21 side, most part of the carrier flown to the magnet 22 side by the screw section 142 hits the housing 13A without directly hitting the magnetic shield. This further ensures prevention of carrier leakage from the magnetic shield to the sealing member 21.

### Fifth Embodiment

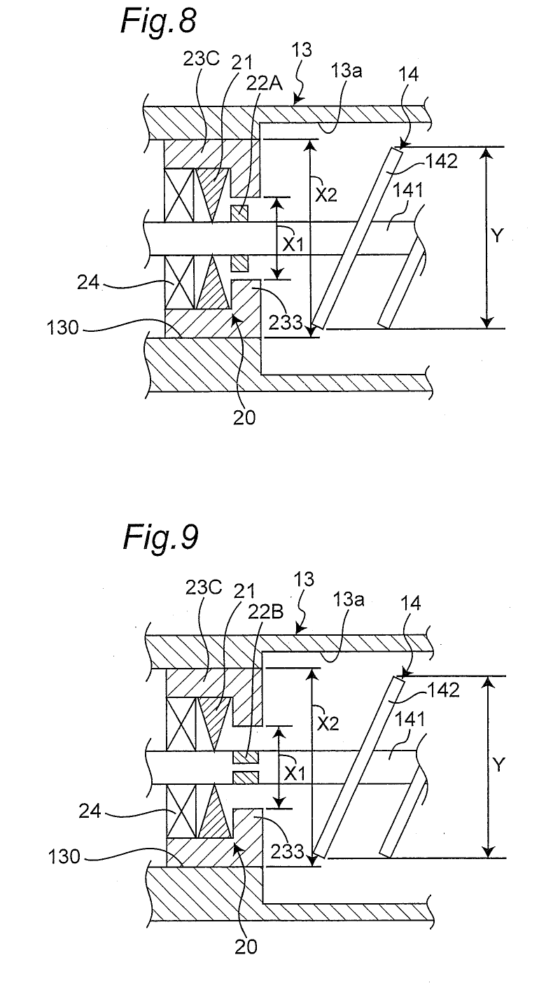

FIG. 8 shows a developing device in a fifth embodiment of the invention. The fifth embodiment is different from the first embodiment in the position of the magnet. It is to be noted that in the fifth embodiment, component members identical to those in the first embodiment are designated by identical reference numerals to omit detailed explanation.

As shown in FIG. 8, a magnet 22A is mounted on the peripheral surface of the shaft section 141 of the agitating conveyance member 14, and has a distance to the housing 13 side. The magnet 22A has the similar configuration to the magnet 22 of the first embodiment.

On the inner surface of a retaining member 23C, a flange 233 projecting radially inside is provided in a part inward in the longitudinal direction of the housing 13. The flange 233 faces the magnet 22A.

An inner diameter X1 of the retaining member 23C inward in the longitudinal direction of the housing 13 is equivalent to an inside diameter of the flange 233, the inner diameter X1 being smaller than the inner diameter X2 of the hole section 130 of the housing 13 inward in the longitudinal direction of the housing 13.

The inner diameter X1 of the retaining member 23C inward in the longitudinal direction of the housing 13C is smaller than the outer diameter Y of the screw section 142 of the agitating conveyance member 14 on the sealing member 21 side.

In the above-configured developing device, the magnet 22A is mounted on the peripheral surface of the shaft section 141 of the agitating conveyance member 14, so that the developer which moves along the shaft of the shaft section 141 can be stopped by the magnet 22A, and therefore the invasion of the developer to the clearance between the sealing member 21 and the shaft section 141 can be reduced.

### Sixth Embodiment

FIG. 9 shows a developing device in a sixth embodiment of the invention. The sixth embodiment is different from the first embodiment in the position of the magnet. It is to be noted that in the sixth embodiment, component members identical to those in the first embodiment are designated by identical reference numerals to omit detailed explanation.

As shown in FIG. 9, a magnet 22B is fitted into a recess part on the peripheral surface of the shaft section 141 of the agitating conveyance member 14, and has a distance to the housing 13 side. The magnet 22B has the similar configuration to the magnet 22 of the first embodiment.

On the inner surface of a retaining member 23C, a flange 233 projecting radially inside is provided in a part inward in the longitudinal direction of the housing 13. The flange 233 faces the magnet 22B.

An inner diameter X1 of the retaining member 23C inward in the longitudinal direction of the housing 13 is equivalent to an inner diameter of the flange 233, the inner diameter X1 being smaller than the inner diameter X2 of the hole section 130 of the housing 13 inward in the longitudinal direction of the housing 13.

The inner diameter X1 of the retaining member 23C inward in the longitudinal direction of the housing 13C is smaller than the outer diameter Y of the screw section 142 of the agitating conveyance member 14 on the sealing member 21 side.

In the above-configured developing device, the magnet 22B is fitted into the recess part on the peripheral surface of the shaft section 141 of the agitating conveyance member 14, so that the size of the device in the direction orthogonal to the shaft of the shaft section 141 can be reduced.

The present invention shall not be limited to the above-disclosed embodiments. For example, the number of agitating conveyance members, sealing members, and magnets can be changed freely. Moreover, the sealing member and the magnet may be provided in at least one end of the shaft section of the agitating conveyance member. The characteristics of the first to sixth embodiments may be combined in various manners, in which, for example, the magnet may be mounted on both the housing side and the shaft section of the agitating conveyance member. The image forming apparatus may be color or monochrome copiers, facsimiles, printers, and the like.

As described above, the developing device of the present invention has the sealing member for sealing a clearance between the housing and the shaft section of the agitating conveyance member and the magnet being placed on an inner side of the sealing member in the housing and forming the magnetic shield in a radial direction orthogonal to the shaft section of the agitating conveyance member. Therefore, the developing device can prevent the shaft section of the agitating conveyance member facing the sealing member from being abraded by the carrier, resulting in prevention of toner leakage caused by the abrasion.

In one embodiment of the invention, the magnet is mounted on the housing side and has a distance to the shaft section of the agitating conveyance member.

In the developing device of this embodiment, the housing has a hole section for receiving the shaft section of the agitating conveyance member, an annular retaining member is mounted on the inner surface of the hole section, and the sealing member is mounted on the inner surface of the retaining member, which allows easy mounting of the sealing member together with the retaining member on the hole section of the housing.

In one embodiment of the invention, the agitating conveyance member has a screw section attached to the shaft section, and a smaller one of an inner diameter of the hole section facing inward the housing and an inner diameter of the retaining member facing inward the housing is smaller than an outer diameter of the screw section of the agitating conveyance member on the sealing member side.

According to the developing device of this embodiment, a smaller one of the inside diameter of the hole section of the housing inside the housing and the inside diameter of the retaining member inside the housing is smaller than the external diameter of the screw section of the agitating conveyance member on the sealing member side, so that most part of the carrier flown to the magnet side by the screw section hits the housing and the retaining member without directly hitting the magnetic shield. This further ensures prevention of carrier leakage from the magnetic shield to the sealing member.

In one embodiment of the invention, the agitating conveyance member has a screw section attached to the shaft section, and the magnet annularly shaped is mounted on the inside of the retaining member, and the inner diameter of the magnet is smaller than the outer diameter of the screw section of the agitating conveyance member on the sealing member side.

According to the developing device of this embodiment, the magnet in an annular shape is mounted on the inner surface of the retaining member, which allows easy mounting of magnet together with the retaining member on the hole section.

Moreover, since the inner diameter of the magnet is smaller than the outer diameter of the screw section of the agitating conveyance member on the sealing member side, most part of the carrier flown to the magnet side by the screw section hits the housing and the retaining member without directly hitting the magnetic shield. This further ensures prevention of carrier leakage from the magnetic shield to the sealing member.

In one embodiment of the invention, the magnet annularly shaped is mounted on the inner surface of the retaining member, and the flange is provided on the inner surface of the retaining member for covering a side surface of the magnet facing inward the housing.

According to the developing device of this embodiment, a flange is provided on the inner surface of the retaining member for covering the side surface of the magnet facing inward the housing, so that invasion of the developer to the magnet and an influence of the magnetism by the magnet upon the inside of the housing can be reduced by the flange.

In one embodiment of the invention, the magnet annularly shaped is mounted on the inner surface of the retaining member, and the flange is provided on the inner surface of the hole section of the housing for covering a side surface of the magnet facing inward the housing.

According to the developing device of this embodiment, a flange is provided on the inner surface of the hole section of the housing for covering the side surface of the magnet facing inward the housing, so that invasion of the developer to the magnet and an influence of the magnetism by the magnet upon the inside of the housing can be reduced by the flange.

In one embodiment of the invention, the magnet is mounted on the shaft section of the agitating conveyance member and has a distance to the housing.

In one embodiment of the invention, the housing has a hole section for receiving the shaft section of the agitating conveyance member, the annular retaining member is mounted on the inner surface of the hole section, and the sealing member is mounted on the inner surface of the retaining member.

In one embodiment of the invention, the developing device has the bearing member for retaining the shaft section of the agitating conveyance member and the bearing member is separated from the sealing member so as not to retain the sealing member

The developing device of this embodiment has a bearing member for holding the shaft section of the agitating conveyance member, the bearing member being separated from the sealing member so as not to retain the sealing member. As a result, the sealing member does not directly receive vibration caused by sliding of the bearing member and the shaft section, which can further secure the sealing property.

The image forming apparatus according to the invention includes the above described developing device.

Since the image forming apparatus of the invention includes the developing device, contamination of the inside of the apparatus by the toner can be prevented.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A developing device comprising:
a housing for storing a developer including a toner and a carrier;
an agitating conveyance member having a shaft section rotatably attached to the housing for conveying, while agitating, the developer in the housing;
a developing roller attached to the housing for carrying the developer conveyed by the agitating conveyance member to feed the carried toner to an image carrier;
a sealing member mounted on the housing for sealing a clearance between the housing and the shaft section of the agitating conveyance member; and
a magnet for providing a magnetic shield in a radial direction orthogonal to the shaft section of the agitating conveyance member, the magnetic shield being positioned in an axial end of the agitating conveyance member and placed on an inner side of the sealing member in the housing.

2. The developing device as claimed in claim 1, wherein
the magnet is mounted on the housing side and has a distance to the shaft section of the agitating conveyance member.

3. The developing device as claimed in claim 1, wherein
the housing has a hole section provided for receiving the shaft section of the agitating conveyance member, an annular retaining member is mounted on an inner surface of the hole section, and the sealing member is mounted on an inner surface of the retaining member.

4. The developing device as claimed in claim 3, wherein
the agitating conveyance member has a screw section attached to the shaft section, and wherein
a smaller one of an inner diameter of the hole section facing inward the housing and an inner diameter of the retaining member facing inward the housing is smaller than an outer diameter of the screw section of the agitating conveyance member on the sealing member side.

5. The developing device as claimed in claim 3, wherein
the agitating conveyance member has a screw section attached to the shaft section, and the magnet annularly shaped is mounted on the inside of the retaining member, and wherein
an inner diameter of the magnet is smaller than an outer diameter of the screw section of the agitating conveyance member on the sealing member side.

6. The developing device as claimed in claim 3, wherein
the magnet annularly shaped is mounted on the inner surface of the retaining member, and wherein
a flange is provided on the inner surface of the retaining member for covering a side surface of the magnet facing inward the housing.

7. The developing device as claimed in claim 3, wherein
the magnet annularly shaped is mounted on the inner surface of the retaining member, and wherein
a flange is provided on the inner surface of the hole section of the housing for covering a side surface of the magnet facing inward the housing.

8. The developing device as claimed in claim 1, wherein
the magnet is mounted on the shaft section of the agitating conveyance member and has a distance to the housing.

9. The developing device as claimed in claim 1 further comprising:
a bearing member for retaining the shaft section of the agitating conveyance member, wherein
the bearing member is separated from the sealing member so as not to retain the sealing member.

10. An image forming apparatus, comprising:
an image carrier capable of carrying an electrostatic latent image based on image data on a surface thereof;
a developing device for feeding a toner to the surface of the image carrier;
a transfer device for transferring the toner image on the image carrier onto a paper sheet; wherein
the developing device comprises:
a housing for storing a developer including the toner and a carrier;
an agitating conveyance member having a shaft section rotatably attached to the housing for conveying, while agitating, the developer in the housing;
a developing roller attached to the housing for carrying the developer conveyed by the agitating conveyance member to feed the carried toner to the image carrier;
a sealing member mounted on the housing for sealing a clearance between the housing and the shaft section of the agitating conveyance member; and
a magnet for providing a magnetic shield in a radial direction orthogonal to the shaft section of the agitating conveyance member, the magnetic shield being positioned at an axial end of the agitating conveyance member and placed on an inner side of the sealing member in the housing.

11. The image forming apparatus as claimed in claim 10, wherein
the magnet is mounted on the housing side and has a distance to the shaft section of the agitating conveyance member.

12. The image forming apparatus as claimed in claim 10, wherein
the housing has a hole section provided for receiving the shaft section of the agitating conveyance member, an annular retaining member is mounted on an inner surface of the hole section, and the sealing member is mounted on an inner surface of the retaining member.

13. The image forming apparatus as claimed in claim 12, wherein
the agitating conveyance member has a screw section attached to the shaft section, and wherein
a smaller one of an inner diameter of the hole section facing inward the housing and an inner diameter of the retaining member facing inward the housing is smaller than an outer diameter of the screw section of the agitating conveyance member on the sealing member side.

14. The image forming apparatus as claimed in claim 12, wherein
the agitating conveyance member has a screw section attached to the shaft section, and the magnet annularly shaped is mounted on the retaining member facing inward the housing, and wherein
an inner diameter of the magnet is smaller than an outer diameter of the screw section of the agitating conveyance member on the sealing member side.

15. The image forming apparatus as claimed in claim 12, wherein
the magnet annularly shaped is mounted on the inner surface of the retaining member, and wherein
a flange is provided on the inner surface of the retaining member for covering a side surface of the magnet facing inward the housing.

16. The image forming apparatus as claimed in claim 12, wherein
the magnet annularly shaped is mounted on the inner surface of the retaining member, and
a flange is provided on the inner surface of the hole section of the housing for covering a side surface of the magnet facing inward the housing.

17. The image forming apparatus as claimed in claim 10, wherein
the magnet is mounted on the shaft section of the agitating conveyance member, and has a distance to the housing.

18. The image forming apparatus as claimed in claim 10, further comprising
a bearing member for retaining the shaft section of the agitating conveyance member, wherein
the bearing member is separated from the sealing member so as not to retain the sealing member.
